(19) United States
(12) Patent Application Publication
(10) Pub. No.: US 2025/0261059 A1
(43) Pub. Date: Aug. 14, 2025

(54) SYSTEMS AND METHODS FOR USER DEVICE HANDOFF BASED ON LOCATION MODELING

(71) Applicant: DISH Wireless L.L.C., Englewood, CO (US)

(72) Inventor: Jeffrey Lang McSchooler, Parker, CO (US)

(21) Appl. No.: 18/438,168

(22) Filed: Feb. 9, 2024

(51) Int. Cl. H04W 36/00; H04W 36/30; H04W 36/32

(52) U.S. Cl. CPC H04W 36/008375; H04W 36/304; H04W 36/322; H04W 36/324; H04W 36/328

(57) ABSTRACT

A device handoff system is described herein. The device handoff system may identify a user device connected to a cell. The device handoff system may access historical data indicating one or more past locations of a user device and predict a future location of the user device based on the user device. The device handoff system may identify at least one cell of a set of cells based on the future location. The device handoff system may cause the user device to connect to the at least one cell.

### BACKGROUND

When user devices connected to a telecommunications network via a cell tower begin to experience a decreased quality of service, the user devices may request a handoff to a different cell tower or to other cells within the current tower in order to increase their quality of service. User devices are typically handed off to the nearest cell with available resources for the user device to connect. It is with respect to this and other considerations that the embodiments described herein have been made.

### BRIEF SUMMARY

The embodiments disclosed herein improve technology that facilitates user device handoffs in a telecommunications network by providing a technical solution that predicts a future location of a user device and identifies a cell to which the user device should be handed off based on the predicted location. The embodiments disclosed herein may access historical data, current data, or some combination thereof, indicating locations of a user device in the past, present, or some combination thereof, and predict a future location of the user device based on this data. The embodiments disclosed herein may also cause a plurality of cells to reserve resources for the user device, such that the user device is able to maintain its quality of service as it is handed off to each of the cells.

In some embodiments, a device handoff system may identify a user device connected to a telecommunications network via a cell of a set of cells. The device handoff system may detect a present location of the user device. The device handoff system may access historical data indicating one or more past locations of the user device. The device handoff system may identify at least one cell of the set of cells based on the predicted future location. The device handoff system may cause the user device to connect to the at least one cell.

In some embodiments, to predict the future location of the user device, the device handoff system determines at least one of a speed of the user device and a direction of travel of the user device. The device handoff system may predict the future location of the user device based on the historical data, the present location of the user device, and at least one of the speed and the direction of travel.

In some embodiments, to predict the future location of the user device, the device handoff system identifies, based on the historical data, one or more of: at least one location at which the user device was located two or more times; at least one amount of time during which the user device was located at one or more locations; and at least one travel path of the user device. The device handoff system may detect a current time. The device handoff system may predict the future location of the user device based on the current time, the historical data, and the present location of the user device.

In some embodiments, to identify at least one cell of the set of cells, the device handoff system predicts a path of the user device based on the predicted future location, the historical data, and the present location of the user device. The device handoff system may identify a plurality of cells based on the predicted path, wherein the plurality of cell towers includes the at least one cell. The device handoff system may determine one or more times at which the user device is to connect to the at least one cell.

In some embodiments, to cause the user device to connect to the at least one cell, the device handoff system causes, for each respective cell of the at least one cell, to reserve networking resources for the user device before a time at which the user device is to connect to the respective cell.

In some embodiments, to cause the user device to connect to the at least one cell, the device handoff system determines a time at which the user device is to connect to the at least one cell based on the historical data and the present location of the user device.

In some embodiments, to predict the future location, the device handoff system identifies one or more measures of the quality of networking services provided to the user device. The device handoff system may determine whether the user device is to connect to a different cell than the cell to which the user device is currently connected based on the one or more measures of the quality of networking service provided to the user device. The device handoff system may, in response to a determination that the user device is to connect to a different cell, predict the future location of the user device based on the historical data and the present location of the user device.

In some embodiments, to identify the at least one cell, the system identifies one or more measures of the quality of networking service provided to the user device. The system may determine whether the user device is to connect to an identified cell based on the one or more measures of the quality of networking services provided to the user device and the predicted future location of the user device. The system may, based on a determination that the device is not to connect to the identified cell, prevent the user device from connecting to the identified cell until it is determined that the user device is to connect to the identified cell.

In some embodiments, to detect the present location of the user device, the system determines an altitude of the user device.

In some embodiments, a user device connects to a network via a first access point of a set of access points associated with the network. The user device may detect a present location of the user device. The user device may access historical data indicating one or more past routes of the user device. The user device may predict a future location of the user device based on the historical data and the connection of the user device to the first access point. The user device may identify a second access point of the set of access points based on the predicted future location. The user device may request that the first access point hand over the connection of the user device from the first access point to the second access point.

In some embodiments, a non-transitory processor-readable storage medium stores at least one of instructions or data that cause a processor to perform a method for user device handoff within a telecommunications network. The method may include identifying a user device connected to an access point of a telecommunications network. The method may include detecting an access point to which the user device is connected. The method may include accessing historical data indicating one or more access points to which the user device was connected in the past. The method may include identifying at least one access point of the set of access points based on the historical data and the detected access point. The method may include causing the user device to connect to the at least one access point.

### BRIEF DESCRIPTION OF THE DRAWINGS

FIG. 1 is a display diagram depicting a sample environment in which a device handoff system operates, according to various embodiments described herein.

FIG. 2 is a block diagram depicting example components incorporated in a device handoff system, according to various embodiments described herein.

FIG. 3 is a flow diagram of a process to identify a cell tower to which a user device is handed off, according to various embodiments described herein.

FIG. 4 is a flow diagram of a process for causing a plurality of cell towers to reserve networking resources for the user device, according to various embodiments described herein.

FIG. 5 is a flow diagram of a process for determining whether a future location should be predicted for a user device, according to various embodiments described herein.

FIG. 6 is a flow diagram of a process for determining whether a user device should connect to an identified cell tower, according to various embodiments described herein.

### DETAILED DESCRIPTION

User devices are handed off to other cells or cell towers in a telecommunications network for a variety of reasons, such as when the quality of service provided by the tower to which a user device is currently connected begins to deteriorate, to manage computing resources of a cell or cell tower or user device, to make “space” for other user devices on a cell or cell tower, to manage power usage of a cell, cell tower or user device, other considerations for handing off a user device to another cell or cell tower, or some combination thereof. For example, a deterioration in quality of service can be due to any number of factors, including: the movement of the user device, obstacles between the user device and the access point, interference caused by other signals, the access point being overloaded by other user devices, changes in altitude of the user device, etc. When the quality of service drops below a threshold level, the user device may be “handed off” to another cell tower, in order to attempt to increase the quality of service provided to the user device.

In conventional systems, the handoff is typically made to the best cell-rsrp (“cell reference signal received power”) available cell tower to the user device other than the cell tower to which the user device is currently connected. However, this handoff does not take into account any of the factors that caused the user device to require a handoff in the first place, thus the user device may continue to be provided with inadequate service in some scenarios. Furthermore, conventional systems are unable to plan or predict when user devices will be near cells or cell towers, and thus cannot reserve, or otherwise plan for, the connection of the user devices to the cells or cell towers. Additionally, conventional systems are unable to account for a situation where a user device is handed off to a first cell or cell tower and then moves to another location such that a second cell or cell tower, in some cases the cell tower that was originally connected to the user device before the hand off, would have provided better service in light of the movement of the user device to the extent that the user device will need handed off again to connect to the second cell tower.

The embodiments disclosed herein improve technology that facilitates user device handoffs in a telecommunications network by providing a technical solution that predicts a future location of a user device and identifies a cell to which the user device should be handed off based on the predicted location. The embodiments disclosed herein may access historical data indicating past locations of a user device and predict a future location of the user device based on the historical data. The embodiments disclosed herein may also cause a plurality of cells to reserve resources for the user device, such that the user device is able to maintain its quality of service as it is handed off to each of the cells.

For example, by predicting a future location of a user device, the embodiments disclosed herein are able to select a cell to which the user device can be handed off and that has a greater likelihood of increasing the time between handoffs because the selected cell is more likely to be able to provide networking services to the user device for a greater amount of time than other cells. Thus, the embodiments disclosed herein are able to reduce the number of hand offs, and thus reduce the amount of computing resources that the user device and cell dedicate to making the hand offs. Furthermore, the embodiments disclosed herein are able to use the predicted location to determine whether a handoff should be performed in the first place, and thus reduce the amount of handoffs and “ping ponging” to cells that the user device will need to be handed off from again in a relatively short period of time. Additionally, the embodiments disclosed herein are able to determine multiple cells, cell towers, or some combination thereof, for the user device to connect to based on a predicted route of the user device, thus reducing the number of handoffs to the lowest amount possible based on the route of the user device.

Unless the context requires otherwise, throughout the specification and claims which follow, the word “comprise” and variations thereof, such as, “comprises” and “comprising” are to be construed in an open, inclusive sense, for example “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. The term “or” is generally employed to include “and/or” unless the content clearly dictates otherwise. The term “and/or” is generally employed to include an inclusive or.

The headings and Abstract of the Disclosure provided herein are for convenience only and do not interpret the scope or meaning of the embodiments.

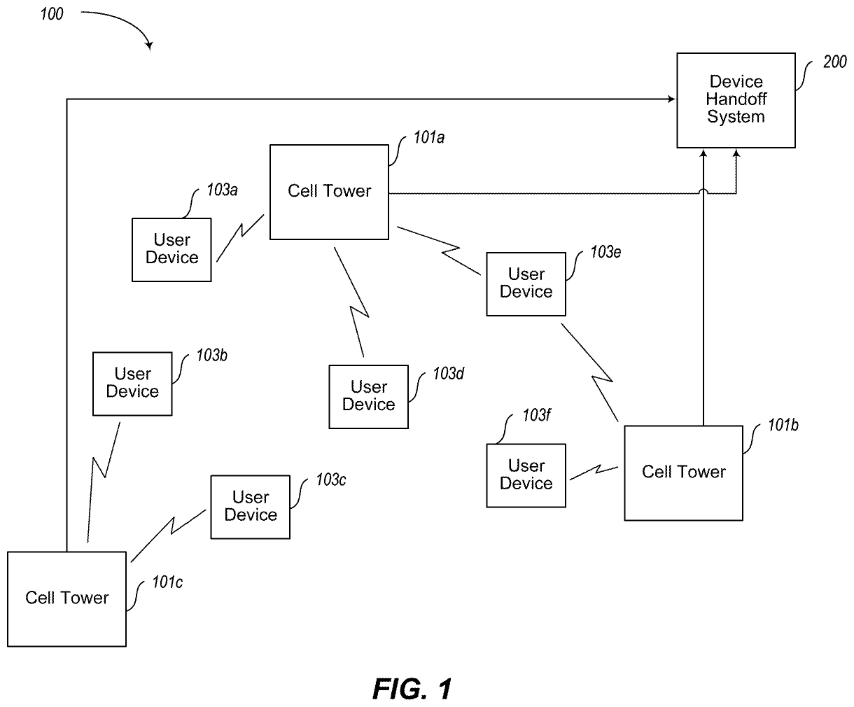

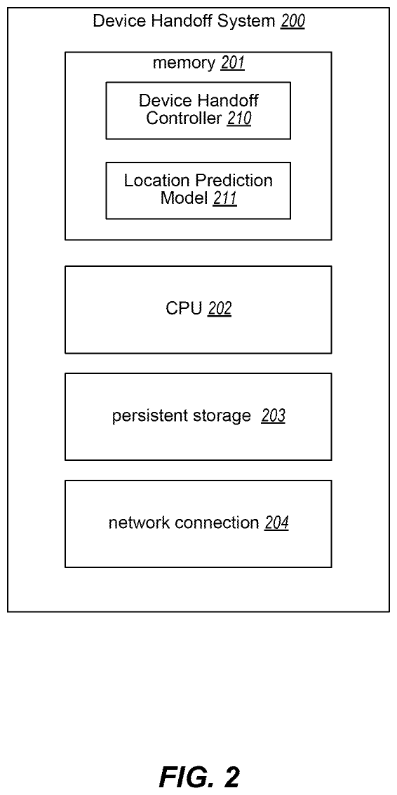

FIG. 1 is a display diagram depicting a sample environment 100 in which a device handoff system 200 operates, according to various embodiments described herein. The environment 100 includes cell towers 101a-101c, user devices 103a-103f, and device handoff system 200. The environment 100 is one instance of an environment in which the device handoff system 200 may operate, and the device handoff system 200 may operate in other environments. Moreover, aspects of the device handoff system 200 may be included in one or more of the devices or cell towers described in FIG. 1, in one or more other computing devices not illustrated in FIG. 1, or some combination thereof. The device handoff system 200 is further discussed below, in connection with FIG. 2.

The cell towers 101a-101c (collectively “cell towers 101” or individually as “cell tower 101”) each include one or more “cells” that operate on a network, such as, for example, a telecommunication network that provides networking services to user devices. In some embodiments, the cell towers 101 may be any type of access point for a network, such as a Wi-Fi network, telecommunications network, or any other network that provides client devices with access to networking services. A cell, such as the cells included in the cell towers 101, may facilitate the transmission and reception of signals to and from devices, such as user devices 103a-103f, connected to a network. A cell may be caused to hand off management of communications between a user device and the cell (a “session”) to another cell. For example, a cell included in the cell tower 101a may manage the session for user device 103e. In this example, the cell included in cell tower 101a receives an indication that the session for user device 103e should be handed off to a cell included in cell tower 101b, and transmits the session to the cell included in cell tower 101b. In some embodiments, a first cell receives an indication that a user device should be handed off to another cell from one or more cell towers, one or more cells, one or more device handoff systems, one or more user devices, or some combination thereof. Additionally, although the embodiments described herein hand off a user device from one cell tower to another, such as from cell tower 101a to cell tower 101b, embodiments are not so limited, and the user device may be handed off from one cell to another cell in the telecommunications network, even if the cells are included in the same cell tower.

In some embodiments, a cell may be a macrocell, microcell, small cell, private cell, femtocell, picocell, or any other type of cell. Thus, although FIG. 1 shows a cell tower that includes cells, embodiments are not so limited, and cells may be included in cell towers, other base stations or access points, or some combination thereof.

The user devices 103a-103f (collectively “user devices 103” or “client devices 103” or individually as “user device 103” or “client device 103”) may be one or more endpoint devices, such as PCs, tablets, laptop computers, smartphones, personal assistants, drones, Internet connection devices, wireless LAN, Wi-Fi, Worldwide Interoperability for Microwave Access (WiMax) devices, or the like, and may be communicatively coupled to the network or to each other so that the plurality of endpoint devices are communicatively coupled together. The client devices 103 may be communicatively coupled to the network via interaction with an access point, such as one or more of the cell towers 101. The client devices 103 may transmit, receive, or some combination thereof, a request to hand off their session with the network to another access point.

The network within which the cell towers 101 and user devices 103 operate may be a network, communication system, or networked system (not shown), to which the user devices 103a-103f, cell towers 101a-101c, and device handoff system 200, may be coupled. Non-limiting examples of such a network or communication system include, but are not limited to, an Ethernet system, twisted pair Ethernet system, an intranet, a local area network (LAN) system, short range wireless network (e.g., Bluetooth®), a personal area network (e.g., a Zigbee network based on the IEEE 802.15.4 specification), a Consumer Electronics Control (CEC) communication system, Wi-Fi, satellite communication systems and networks, cellular networks, cable networks, or the like.

FIG. 2 is a block diagram depicting example components incorporated in a device handoff system 200, according to various embodiments described herein.

The device handoff system 200 may be: located on a network in a position to communicate with one or more cell towers, user devices, or any entity associated with any of the nodes, cell towers, user devices, or network; integrated as part of a node or cell tower, such as the cell towers 101; or located at any other devices in which the device handoff system 200 is able to perform at least some of its functions. In various embodiments, the device handoff system 200 includes one or more of the following: a computer memory 201, a processor 202, a persistent storage device 203, and a network connection 204. The memory 201 may be used for storing programs and data while they are being used, including data associated with the various data requirements of user devices or cell towers (not shown), coverage requirements of user devices or cell towers (not shown), cell towers, user devices, interfering devices, an operating system including a kernel (not shown), device drivers (not shown), and one or more machine learning models. The processor 202 may be used for executing computer programs (not shown), such as computer programs which perform some or all of the functions of the device handoff system. In some embodiments, the processor 202 may be one or more processors, microcontrollers, or other computer components. In some embodiments, any of the processors, microcontrollers, or other computer components, either alone or in combination, can perform any of the functions or acts described herein. The persistent storage device 203 may be a hard drive, memory (ie. EEPROM) or flash drive for persistently storing programs and data. The network connection 204 may be used for connecting to one or more cell towers or other computer systems (not shown), to send or receive data, such as via the Internet or another network and associated networking hardware, such as switches, routers, repeaters, electrical cables and optical fibers, light emitters and receivers, radio transmitters and receivers, and the like, and to scan for and retrieve signals associated with user devices, cell towers, devices or components associated with the network, and for connecting to one or more computer devices such as cell towers, user devices, devices or components associated with the network, or other computer systems. In various embodiments, the device handoff system 200 additionally includes input and output devices, such as a keyboard, a mouse, display devices, etc. In some embodiments, all or part of the device handoff system 200 is included within a cell tower, such as the cell towers 101 described above in connection with FIG. 1.

While a device handoff system 200 configured as described may be used in some embodiments, in various other embodiments, the device handoff system 200 may be implemented using devices of various types and configurations and having various components. The memory 201 may include a device handoff controller 210, which contains computer-executable instructions that, when executed by the CPU 202, cause the device handoff system 200 to perform the operations and functions described herein. For example, the programs referenced above, which may be stored in computer memory 201, may include or be comprised of such computer-executable instructions. The memory 201 may also include a device handoff data structure (not shown), which includes data related to operations performed by the device handoff system, and a location prediction model 211 that determines a coverage requirement for a user device.

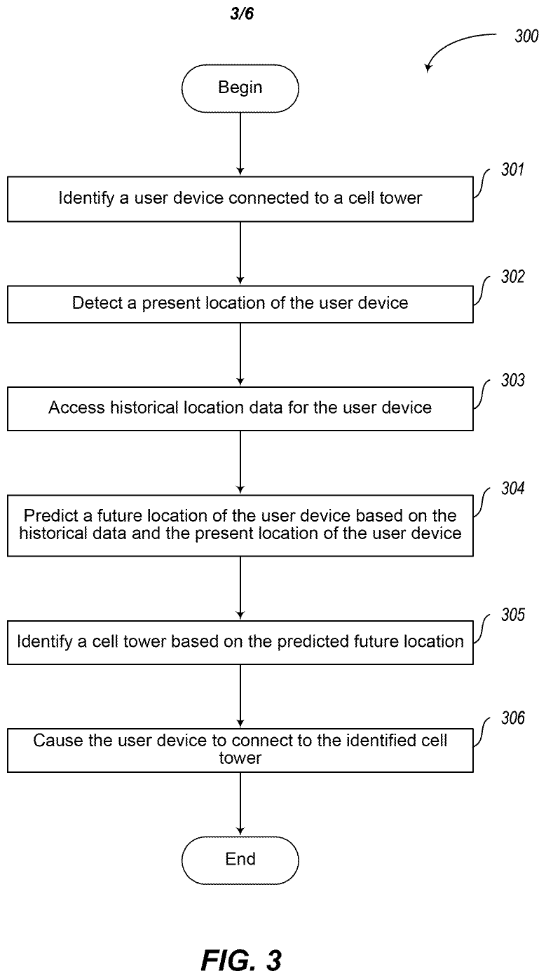

The device handoff controller 210 performs the core functions of the device handoff system 200, as discussed herein and also with respect to FIGS. 3-6. In particular, the device handoff controller 210 predicts a future location of a user device and identifies a cell or cell tower to which the user device is to be handed off based on the future location. Additionally, the device handoff controller 210 may cause cells or cell towers to reserve networking resources for the user device. The device handoff controller 210 may also perform other functions related to device hand offs, identifying a cell or cell tower to which the user device is to be handed off, determining whether a device should be handed off to a cell or cell tower, etc.

The location prediction model 211 is an artificial intelligence or machine learning model that is trained to predict a future location of a user device. The location prediction model 211 may be trained with historical data, such as: past routes of the user device; past locations of the user device; past access points, including cell towers, to which the user device has connected; other data related to a user device, its location, or its connectivity to a network; other data indicating one or more of routes, locations, access points, etc. related to other user devices; or any combination thereof. The location prediction model 211 may be trained from various input, such as: a route of the user device, a present location of a user device, data indicating a cell tower to which the user device is connected, a future time at which the location should be predicted, or other data indicating where or how the user device is connecting to the network, or any combination thereof. The location prediction model 211 may output one or more of: a predicted future location, a predicted future route, and one or more predicted access points.

In an example embodiment, the device handoff controller 210 or computer-executable instructions stored on memory 201 of the device handoff system 200 are implemented using standard programming techniques. For example, the device handoff controller 210 or computer-executable instructions stored on memory 201 of the device handoff system 200 may be implemented as a “native” executable running on CPU 202, along with one or more static or dynamic libraries. In other embodiments, the device handoff controller 210 or computer-executable instructions stored on memory 201 of the device handoff system 200 may be implemented as instructions processed by a virtual machine that executes as some other program.

The embodiments described above may also use synchronous or asynchronous client-server computing techniques. However, the various components may be implemented using more monolithic programming techniques as well, for example, as an executable running on a single processor computer system, or alternatively decomposed using a variety of structuring techniques known in the art, including but not limited to, multiprogramming, multithreading, client-server, or peer-to-peer, running on one or more computer systems each having one or more processors. Some embodiments may execute concurrently and asynchronously, and communicate using message passing techniques. Equivalent synchronous embodiments are also supported. Also, other functions could be implemented or performed by each component/module, and in different orders, and by different components/modules, yet still achieve the functions of the device handoff controller 200.

In addition, programming interfaces to the data stored as part of the device handoff controller 210 can be available by standard mechanisms such as through C, C++, C #, Java, and web APIs; libraries for accessing files, databases, or other data repositories; through scripting languages such as JavaScript and VBScript; or through Web servers, FTP servers, or other types of servers providing access to stored data. The device handoff controller 210 may be implemented by using one or more database systems, file systems, or any other technique for storing such information, or any combination of the above, including implementations using distributed computing techniques.

Different configurations and locations of programs and data are contemplated for use with techniques described herein. A variety of distributed computing techniques are appropriate for implementing the components of the embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions of the device handoff controller 200.

Furthermore, in some embodiments, some or all of the components/portions of the device handoff controller 210, or functionality provided by the computer-executable instructions stored on memory 201 of the device handoff system 200 may be implemented or provided in other manners, such as at least partially in firmware or hardware, including, but not limited to, one or more application-specific integrated circuits (ASICs), standard integrated circuits, controllers (e.g., by executing appropriate instructions, and including microcontrollers or embedded controllers), field-programmable gate arrays (FPGAs), complex programmable logic devices (CPLDs), and the like. Some or all of the system components or data structures may also be stored as contents (e.g., as executable or other machine-readable software instructions or structured data) on a computer-readable medium (e.g., as a hard disk; a memory; a computer network or cellular wireless network; or a portable media article to be read by an appropriate drive or via an appropriate connection, such as a DVD or flash memory device) so as to enable or configure the computer-readable medium or one or more associated computing systems or devices to execute or otherwise use or provide the contents to perform at least some of the described techniques. Such computer program products may also take other forms in other embodiments. Accordingly, embodiments of this disclosure may be practiced with other computer system configurations.

In general, a range of programming languages may be employed for implementing any of the functionality of the user devices, cells, cell towers, interface mitigation system, interfering devices, etc., present in the example embodiments, including representative implementations of various programming language paradigms and platforms, including but not limited to, object-oriented (e.g., Java, C++, C #, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, PHP, Python, JavaScript, VBScript, and the like) and declarative (e.g., SQL, Prolog, and the like).

The operation of certain aspects will now be described with respect to FIGS. 3-6. In at least one of various embodiments, at least a portion of the processes 300, 400, 500, and 600 described in conjunction with FIGS. 3-6, respectively, may be implemented by one or more processors or executed via circuitry on one or more computing devices, such as the device handoff system 200 described in connection with FIG. 2, the user devices 103 described in connection with FIG. 1, the cell towers 101 described in connection with FIG. 1, one or more cells included in one or more cell towers, other computing devices, or some combination thereof.

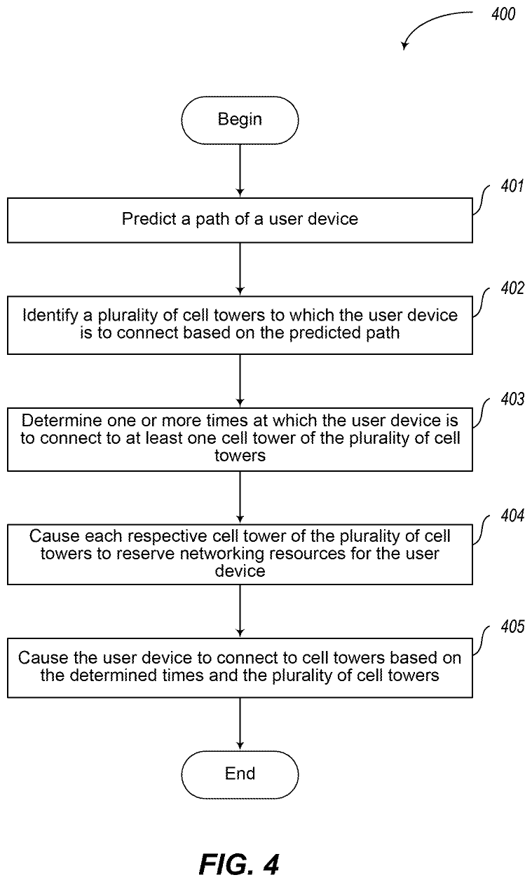

FIG. 3 is a flow diagram of a process 300 to identify a cell tower to which a user device is handed off, according to various embodiments described herein. The process 300 may be performed by a device handoff system, such as the device handoff system 200 described above with respect to FIGS. 1 and 2. In some embodiments, as part of performing the acts included in the process 300, the network configuration system performs one or more of the acts included in the processes 400, 500, and 600 described below in connection with FIGS. 4-6.

The process 300 begins, at act 301, where the device handoff system identifies a user device connected to a cell tower. In some embodiments, at act 301, the device handoff system identifies a user device connected to an access point. The cell tower may be associated with a telecommunications network configured to provide one or more network functions to the user device. The telecommunications network may be configured to provide service to the user device greater than a threshold quality of service, such as bandwidth, call quality, network quality, network speed, or other measures of a quality of service provided to a user device by a network.

The process 300 proceeds to act 302, where the device handoff system detects a present location of the user device. In some embodiments, the device handoff system does not perform act 302, and performs at least one act associated with one or more of processes 300, 400, 500, or 600, with respect to a cell tower or access point instead of to the present location of the user device. In some embodiments, the present location includes one or more coordinates indicating a location of the user device. In some embodiments, the detected present location includes an altitude of the user device. In some embodiments, the altitude of the user device is determined based on barometric pressure data indicating the barometric pressure of an area within which the user device is located. In some embodiments, the present location is determined based on one or more of: an emergency location service (ELS), hybridized emergency location (HELO), a location of one or more access points, global positioning system (GPS) data, or other methods of determining a location of the user device.

The process 300 proceeds to act 303, where the device handoff system accesses historical location data for the user device. The historical location data may be or include data similar to the historical data used to train the location prediction model 211 described above in connection with FIG. 2. In some embodiments, at act 303, the device handoff system identifies, via the historical data, one or more of: at least one location at which the user device was located two or more times; at least one amount of time during which the user device was located at one or more locations; and at least one travel path of the user device.

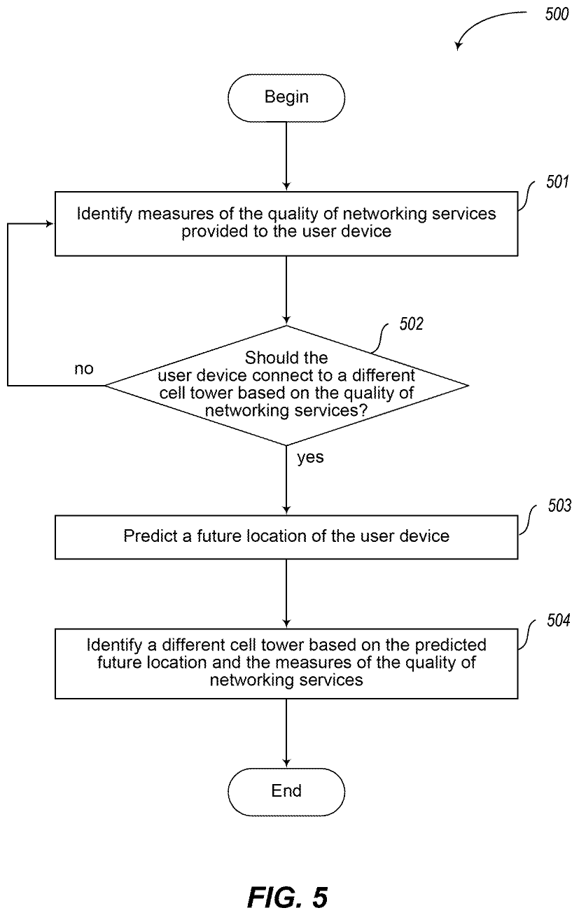

The process 300 proceeds to act 304, where the device handoff system predicts a future location of the user device based on the historical data and the present location of the user device. In some embodiments, such as embodiments where the device handoff system does not perform act 302, the device handoff system does not perform act 304. In some embodiments, as part of performing act 304, the device handoff system performs at least a portion of the process 500 described below in connection with FIG. 5. In some embodiments, the device handoff system predicts the future location of the user device at least based on statistical analysis of the historical data.

In some embodiments, at act 304, the device handoff system identifies data indicating movement of the user device, such as by determining at least one of a speed of the user device, a direction of travel of the user device, a velocity of the user device, an acceleration of the user device, or some combination thereof. In such embodiments, the device handoff system may use the data indicating the movement of the user device to predict the future location of the user device.

In some embodiments, at act 304, the device handoff system detects a current time. In such embodiments, the device handoff system may predict the future location based on the current time and at least one of: the historical data and the present location of the user device.

In some embodiments, to predict the future location, the device handoff system uses a location prediction model, such as the location prediction model 211 described above in connection with FIG. 2.

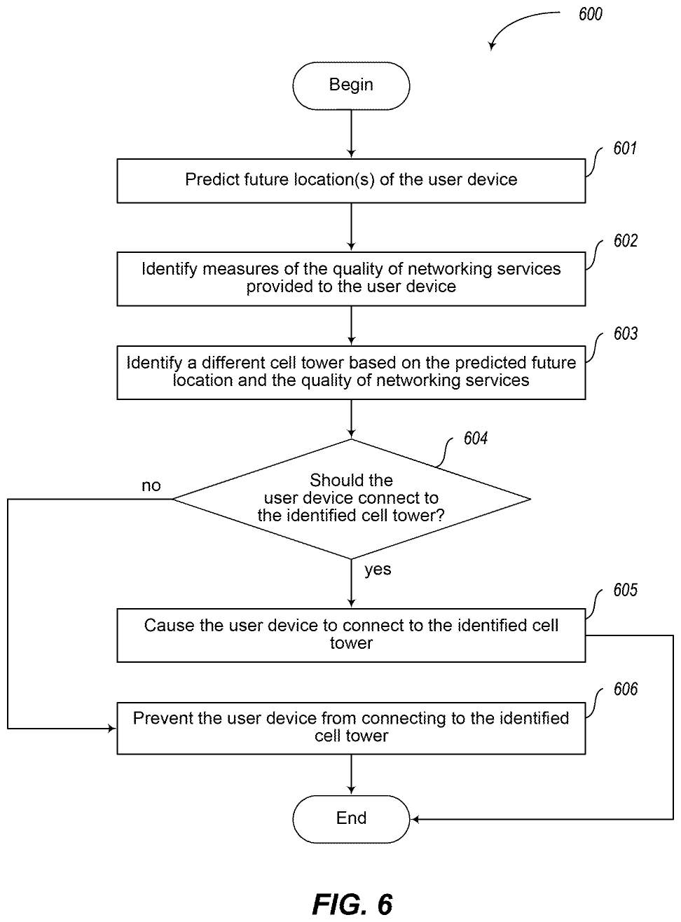

The process 300 proceeds to act 305, where the device handoff system identifies a cell tower based on at least the predicted future location. In some embodiments, the device handoff system identifies the cell tower based on the predicted future location and the present location. In some embodiments, the device handoff system identifies the cell tower based on at least the historical data. In some embodiments, such as embodiments where the device handoff system does not perform act 302, the device handoff system identifies the cell tower based on a cell tower or access point instead of to the predicted future location. In some embodiments, as part of performing act 305, the device handoff system performs at least a portion of the process 600 described below in connection with FIG. 6. In some embodiments, the device handoff system does not use one or two of the predicted future location, the present location, or the historical data to identify the cell tower.

The process 300 proceeds to act 306, where the device handoff system causes the user device to connect to the identified cell tower. In some embodiments, the device handoff system performs act 306 by transmitting instructions to the user device to transfer its connection to another cell tower, to request a handoff to another cell tower, to perform other actions that would cause the user device to be handed off to another cell tower, or some combination thereof. In some embodiments, the device handoff system causes the user device to connect to the identified cell tower by instructing the cell tower to which the user device is currently connected to hand off the user device to the identified cell tower.

In some embodiments, the device handoff system determines a time at which the user device is to connect to the identified cell tower based on at least the historical data. In some embodiments, the device handoff system determines the time at which the user device is to connect to the identified cell tower based on at least the present location of the user device.

In some embodiments, the device handoff system identifies multiple cell towers to which the user device should be handed off. In such embodiments, the device handoff system may determine one or more times at which the user device is to connect to each of at least a portion of the identified cell towers. The device handoff system may identify multiple cell towers via the process 400 described below in connection with FIG. 4.

After act 306, the process 300 ends. Although FIG. 3 describes a process to identify a cell tower to which a user device is handed off, embodiments are not so limited, and the process 300 can be performed to identify a cell to which a user device is handed off.

FIG. 4 is a flow diagram of a process 400 for causing a plurality of cell towers to reserve networking resources for the user device, according to various embodiments described herein. The process 400 may be performed by a device handoff system, such as the device handoff system 200 described above with respect to FIG. 2.

The process 400 begins, after a start block, at act 401, where the device handoff system predicts a path of the user device. The device handoff system may predict the path of the user device based on one or more of: historical data, a present location of the user device, data indicating movement of the user device, and other data. In some embodiments, the device handoff system predicts a path of the user device by predicting multiple future locations of the user device, such as in a similar manner to act 304 described above in connection with FIG. 3.

The process 400 proceeds to act 402, where the device handoff system identifies a plurality of cell towers to which the user device is to connect based on the predicted path. In some embodiments, the device handoff system performs act 402 in a similar manner to act 305, described above in connection with FIG. 3.

The process 400 proceeds to act 403, where the device handoff system determines one or more times at which the user device is to connect to at least one cell tower of the plurality of cell towers. In some embodiments, the one or more times may indicate that a user device is to connect to the same cell tower at two or more different times.

The process 400 proceeds to act 404, where the device handoff system causes each respective cell tower of the plurality of cell towers to reserve networking resources for the user device. In some embodiments, the device handoff system does not perform act 404. In some embodiments, reserving networking resources for a user device may include ensuring a threshold amount of bandwidth is available for a user device, pre-registering a user device with a cell tower, other methods of ensuring networking resources used to manage a user device session with a cell tower are reserved for management of the user device, or some combination thereof.

The process 400 proceeds to act 405, where the device handoff system causes the user device to connect to cell towers based on the determined times and the plurality of cell towers. In some embodiments, the device handoff system performs act 405 in a similar manner to act 306, described above in connection with FIG. 3.

After act 405, the process 400 ends. In some embodiments, as part of performing at least one of acts 402 and 403, the device handoff system performs at least a portion of one or more of processes 500 and 600, described below in connection with FIGS. 5 and 6 respectively.

In an example embodiment, the device handoff system may predict the path of the user device based on a selected starting location, ending location, intermediate location, time, or other factor related to predicting a path of a user device. For example, the device handoff system may recognize that a user device is traveling towards a location, such as a mall, from a home of an owner of the user device based on historical data, a location of the user device, data indicating movement of the user device, or some combination thereof. The device handoff system may predict an amount of time that the user device will be located at the mall, and when the user device will begin moving towards the home of the owner of the user device. The device handoff system may then use the process 400 to identify cell towers to which the user device is to connect as it travels towards the mall, while it is located at the mall, and as it is travelling back from the mall.

In another example, the device handoff system may use the historical data to determine whether a user device travels along a path at one or more “regular” times, according to a schedule, etc., such as when an owner of the user device commutes to work. A regular time may be a time that a user routinely or semi-routinely travels along a same or similar path. In this example, the device handoff system may use the process 400 to identify cell towers and reserve networking resources provided by the identified cell towers. In this example, the device handoff system causes the user device to be handed off to the identified cell towers during the commute. Thus, the quality of networking services provided to the user device can be maintained during the commute.

In some embodiments, the device handoff system may determine one or more alternate predicted paths of the user device. In such embodiments, the device handoff system may prioritize, rank, or otherwise differentiate each of the predicted paths of the user device. The device handoff system may use the differentiation of the predicted paths of the user device to identify cells or cell towers for which networking resources are to be reserved for the user device, such as by using the process 400. In some embodiments, the device handoff system may differentiate predicted paths of the user device based on an expected quality of networking services provided to the user device when the user device follows each respective predicted path. The device handoff system may determine the expected quality of networking services provided to the user device based on a current status of one or more cells or cell towers along the predicted path; a predicted future status of one or more cells or cell towers along the predicted path; one or more attributes of the user device, such as the hardware, software or other components of the user device, the battery or power level of the user device, one or more settings of the user device, or other indications of the status of a user device; or other data or considerations for determining an expected quality of networking services for a user device.

In some embodiments, the device handoff system may transmit data indicating the predicted path, one or more alternate predicted paths, differentiation of the predicted paths, or some combination thereof, to the user device. For example, the data transmitted to the user device may include a depiction of a path that is displayed to a user of the user device and an indication of an expected quality of service that the user device will receive if the user device follows the predicted path.

Although FIG. 4 describes a process for causing a plurality of cell towers to reserve networking resources for the user device, embodiments are not so limited, and the process 400 can be performed to cause one or more cells to reserve networking resources for the user device.

FIG. 5 is a flow diagram of a process 500 for determining whether a future location should be predicted for a user device, according to various embodiments described herein. The process 500 may be performed by a device handoff system, such as the device handoff system 200 described above with respect to FIG. 2.

The process 500 begins, after a start block, at act 501, where the device handoff system identifies measures of the quality of networking services provided to the user device by a cell tower or cell to which the user device is connected.

The process 500 proceeds to act 502, where the device handoff system determines whether a user device is to connect to a different cell tower based on the measures of the quality of networking services. In some embodiments, at act 502, the device handoff system determines whether a user device is to connect to a different cell. In some embodiments, the device handoff system determines whether one or more of the measures of the quality of networking services exceeds a threshold level, is outside of a threshold range, or some combination thereof. If the device handoff system determines that the user device should not connect to a different cell tower, the process 500 proceeds back to act 501, otherwise, the process 500 proceeds to act 503. In some embodiments, by determining whether the user device should connect to a different cell tower, the device handoff system prevents the user device from being handed off to a different cell tower until it is necessary for the user device to connect to a different cell tower to maintain a threshold level of quality of service, until a time at which the user device must connect to a different cell tower to maintain a threshold level of quality of service is near, or some combination thereof.

At act 503, the device handoff system predicts a future location of the user device. The device handoff system may perform act 503 in a similar manner to act 304, described above in connection with FIG. 3. In some embodiments, the device handoff system predicts a path of the user device, such as in a similar manner to act 401, described above in connection with FIG. 4.

The process 500 proceeds to act 504, where the device handoff system identifies at least one different cell tower based on the predicted future location and the measures of the quality of networking services. In some embodiments, the device handoff system performs act 504 in a similar manner to act 305 or act 404, described above in connection with FIGS. 3 and 4 respectively. In some embodiments, at act 504, the device handoff system identifies at least one different cell based on the predicted future location and the measures of the quality of networking services.

After act 504, the process 500 ends. In an example embodiment, the device handoff system may detect that the quality of networking services provided to the user device is deteriorating. In response to this determination, the device handoff system may predict a future location of the device and identify a cell tower to which the device should be handed off based on the predicted future location.

FIG. 6 is a flow diagram of a process 600 for determining whether a user device should connect to an identified cell tower, according to various embodiments described herein. The process 600 may be performed by a device handoff system, such as the device handoff system 200 described above with respect to FIG. 2.

The process 600 begins, after a start block, at act 601, where the device handoff system predicts one or more future locations of the user device. The device handoff system may perform act 601 in a similar manner to act 503, described above in connection with FIG. 5.

The process 600 proceeds to act 602, where the device handoff system identifies one or more measures of the quality of networking services provided to the user device by the cell tower to which the user device is currently connected. The device handoff system may perform act 602 in a similar manner to act 501.

The process 600 proceeds to act 603, where the device handoff system identifies a different cell tower based on the predicted future location and the measures of the quality of networking services. The device handoff system may perform act 603 in a similar manner to act 504, described above in connection with FIG. 5. In some embodiments, at act 603, the device handoff system identifies at least one different cell based on the predicted future location and the measures of the quality of networking services.

The process 600 proceeds to act 604, where the device handoff system determines whether the user device should connect to the identified cell tower. The device handoff system may perform act 604 in a similar manner to act 502, described above in connection with FIG. 5. In some embodiments, at act 604, the device handoff system determines whether a user device should connect to an identified cell. In some embodiments, as part of performing act 604, the device handoff system determines one or more measures of the quality of networking services that the identified cell tower is able to provide to the user device. If the device handoff system determines that the user device should connect to the identified cell tower, the process 600 proceeds to act 605, otherwise, the process 600 proceeds to act 606.

At act 605, the device handoff system causes the user device to connect to the identified cell tower. The device handoff system may perform act 605 in a similar manner to act 504, described above in connection with FIG. 5.

At act 606, the device handoff system prevents the user device from connecting to the identified cell tower.

After act 606 or act 605, the process 600 ends. In an example embodiment, the device handoff system may identify a cell tower to which the user device should be handed off, but may later determine, before the user device is handed off to the identified cell tower, that the quality of networking services that the cell tower is able to provide would not exceed a threshold level. In this example, the device handoff system prevents the user device from connecting to the identified cell tower because doing so would result in a worse quality of networking services for the user device than remaining connected to the current cell tower to which the user device is connected. The device handoff system may perform in this manner to prevent the user device from connecting to a cell tower even if the cell tower was included in a plurality of cell towers to which the user device was planned to connect. Although embodiments described herein describe preventing a handoff due to the quality of networking services able to be provided by a cell tower, embodiments are not so limited, and the device handoff system may prevent a handoff for other reasons, such as to manage computing resources for a cell tower or user device, to manage power usage by a cell tower or user device, other considerations that may be taken into account when determining whether a user device should be handed off to another cell tower, or some combination thereof.

In another example embodiment, the device handoff system may detect that although the current quality of networking services is below a threshold amount, the user device is likely to soon be in a location where the quality of networking services would improve, based on a predicted location of the user device. In such an example embodiment, the device handoff system prevents the user device from being handed off to another cell tower to conserve computing and networking resources that would otherwise be expended to connect to a different cell tower in a situation where there was not a need to do so, such as a situation in which handing off the user device to a different cell tower would prevent the user device from experiencing a level of quality of service below the threshold quality of service for less than a threshold amount of time.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system for user device handoff within a telecommunications network, the system comprising:
at least one processor;
at least one memory coupled to the at least one processor, the memory having computer-executable instructions stored thereon that, when executed by the at least one processor, cause the system to:
identify a user device connected to the telecommunications network via a cell of a set of cells;
detect a present location of the user device;
access historical data indicating one or more past locations of the user device;
predict a future location of the user device based on the historical data and the present location of the user device;
identify at least one cell of the set of cells based on the predicted future location; and
cause the user device to connect to the at least one cell.

2. The system of claim 1, wherein to predict the future location of the user device, the computer-executable instructions, when executed by the at least one processor, further cause the system to:
determine at least one of a speed of the user device and a direction of travel of the user device; and
predict the future location of the user device based on the historical data, the present location of the user device, and at least one of the speed and the direction of travel.

3. The system of claim 1, wherein to predict the future location of the user device, the computer-executable instructions, when executed by the at least one processor, further cause the system to:
identify, based on the historical data one or more of:
at least one location at which the user device was located two or more times;
at least one amount of time during which the user device was located at one or more locations; and
at least one travel path of the user device;
detect a current time; and
predict the future location of the user device based on the current time, the historical data, and the present location of the user device.

4. The system of claim 1, wherein to identify at least one cell of the set of cells, the computer-executable instructions, when executed by the at least one processor, further cause the system to:
predict a path of the user device based on the predicted future location, the historical data, and the present location of the user device;
identify a plurality of cells based on the predicted path, the plurality of cells including the at least one cell; and
determine one or more times at which the user device is to connect to the at least one cell.

5. The system of claim 4, wherein to cause the user device to connect to the at least one cell, the computer-executable instructions, when executed by the at least one processor, further cause the system to:
for each respective cell of the at least one cell:
cause the respective cell to reserve networking resources for the user device before a time at which the user device is to connect to the respective cell.

6. The system of claim 1, wherein to cause the user device to connect to the at least one cell, the computer-executable instructions, when executed by the at least one processor, further cause the system to:
determine a time at which the user device is to connect to the at least one cell based on the historical data and the present location of the user device.

7. The system of claim 1, wherein to predict the future location, the computer-executable instructions, when executed by the at least one processor, further cause the system to:
identify one or more measures of the quality of networking services provided to the user device;
determine whether the user device is to connect to a different cell than the cell to which the user device is currently connected based on the one or more measures of the quality of networking services provided to the user device; and
in response to a determination that the user device is to connect to a different cell, predict the future location of the user device based on the historical data and the present location of the user device.

8. The system of claim 1, wherein to identify the at least one cell, the computer-executable instructions, when executed by the at least one processor, further cause the system to:
identify one or more measures of the quality of networking services provided to the user device;
determine whether the user device is to connect to an identified cell based on the one or more measures of the quality of networking services provided to the user device and the predicted future location of the user device; and
based on a determination that the device is not to connect to the identified cell, prevent the user device from connecting to the identified cell until it is determined that the user device is to connect to the identified cell.

9. The system of claim 1, wherein to detect the present location of the user device, the computer-executable instructions, when executed by the at least one processor, further cause the system to:
determine an altitude of the user device.

10. A method performed by a user device, the method comprising:
connecting to a network via a first access point of a set of access points associated with the network;
accessing historical data indicating one or more past routes of the user device;
predicting a future location of the user device based on the historical data and the connection of the user device to the first access point;
identifying a second access point of the set of access points based on the predicted future location; and
requesting that the first access point hand over the connection from the first access point to the second access point.

11. The method of claim 10, wherein identifying at least one access point based on the predicted future location comprises:
accessing data indicating a present location of the user device;
predicting a route of the user device based on the predicted future location and the present location of the user device;
identifying a plurality of access points based on the predicted route and the set of access points associated with the network; and
determining one or more times at which the user device is to connect to at least one access point of the plurality of access points.

12. The method of claim 11, wherein causing the user device to connect to the at least one access point comprises:
for each respective access point of the at least one access point:
cause the respective access point to reserve networking resources for the user device before a time at which the user device is to connect to the respective access point.

13. The method of claim 11, wherein predicting the future location comprises:
accessing data indicating a present location of the user device;
identifying one or more measures of the quality of networking services provided to the user device;
determining whether the user device is to connect to a different access point than the access point to which the user device is currently connected based on the one or more measures of the quality of networking services provided to the user device; and
in response to a determination that the user device is to connect to a different access point, predicting the future location of the user device based on the historical data and the present location of the user device.

14. The method of claim 11, wherein predicting the future location comprises:
accessing data indicating a present location of the user device;
identifying, based on the historical data one or more of:
at least one location in which the user device was located two or more times;
at least one amount of time during which the user device was located at one or more locations; and
at least one travel path of the user device; and
predicting the future location of the user device based on the current time, the historical data, and the present location of the user device.

15. A non-transitory processor-readable storage medium that stores at least one of instructions or data, the instructions or data, when executed by at least one processor, cause the at least one processor to perform a method comprising:
identifying a user device connected to an access point of a telecommunications network;
detecting an access point to which the user device is connected;
accessing historical data indicating one or more access points to which the user device was connected in the past;
identifying at least one access point of the set of access points based on the historical data and the detected access point; and
causing the user device to connect to the at least one access point.

16. The non-transitory processor-readable storage medium of claim 15, wherein identifying the at least access point comprises:
determining a velocity of the user device; and
identifying the access point based on the historical data, the detected access point, and the velocity of the user device.

17. The non-transitory processor-readable storage medium of claim 16, wherein identifying the at least one access point further comprises:
identifying, based on the historical data one or more of:
at least one access point to which the user device was connected two or more times;
at least one amount of time during which the user device was connected to one or more access points; and
at least one travel path of the user device; and
identifying the at least one access point based on a current time, the historical data, the detected access point, and the velocity of the user device.

18. The non-transitory processor-readable storage medium of claim 15, wherein identifying at least one access point comprises:
predicting a path of the user device based on the historical data and the detected access point; and
identifying a plurality of access points based on the predicted path.

19. The non-transitory processor-readable storage medium of claim 15, wherein causing the user device to connect to the at least one access point comprises:
determining one or more times at which the user device is to connect to at least one access point of the plurality of access points; and
for each respective access point of the at least one access points:
causing the respective access point to reserve networking resources for the user device before a time at which the user device is to connect to the respective access point.

20. The non-transitory processor-readable storage medium of claim 15, wherein identifying at least one access point comprises:
identifying one or more measures of the quality of networking services provided to the user device;
determining whether the user device is to connect to a different access point than the access point to which the user device is currently connected based on the one or more measures of the quality of networking services provided to the user device; and
in response to a determination that the user device is to connect to a different access point, identify the at least one access point based on the historical data and the detected access point.
